(19) United States
(12) Patent Application Publication
(10) Pub. No.: US 2017/0278034 A1
(43) Pub. Date: Sep. 28, 2017

(54) CREATING ALTERNATIVE WELLNESS ACTIVITIES BASED ON TRACKED WORKER ACTIVITY

(71) Applicant: International Business Machines Corporation, Armonk, NY (US)

(72) Inventors: Palanivel A. Kodeswaran, Bangalore (IN); Ravindranath Kokku, Yorktown Heights, NY (US); Ramasuri Narayanam, Bangalore (IN); Sayandeep Sen, Bangalore (IN)

(21) Appl. No.: 15/079,973

(22) Filed: Mar. 24, 2016

(51) Int. Cl. G06Q 10/06; H04L 29/08; G09B 19/00; H04L 12/58

(52) U.S. Cl. CPC G06Q 10/0639; H04L 51/046; H04L 67/18; G09B 19/003

(57) ABSTRACT

One embodiment provides a method for creating alternative wellness activities based on tracked worker activity, the method including: utilizing at least one processor to execute computer code that performs the steps of: receiving, from one or more device sensors, a user movement pattern; identifying, based on the user movement pattern, an activity; determining, using at least one other device sensor, an alternative user movement pattern to achieve the activity, wherein said alternative increases an activity level of a user; and communicating, over a network, a message suggesting the alternative user movement pattern. Other aspects are described and claimed.

### BACKGROUND

According to the United Nations Department of Economic and Social Affairs, more people are now living in urban areas than rural areas. Although this societal transition from rural to urban is due to many factors, one of the factors that allowed this transition to take place is the rise of the office job. A large number of people now work in an office space, which typically causes them to be sedentary for most of the day. Although this system has allowed for advancements in society, it isn't particularly healthy for the individual. In addition to health concerns, a stationary life style has been shown to have a negative impact to an individual's overall mental wellbeing.

Working long hours with very little physical activity can lead to sickness, physical health issues, mental health issues, and the like. Illnesses may lead to time off or reduced worker productivity, which when viewed at the macroscopic level can cost a company a great deal of money and time. Thus, the concept of maintaining a healthy workforce is vital not only for the individual worker's benefit, but for a company itself. Monitoring and improving both the physical and mental health of a work force has been shown to increase productivity, efficiency, and perhaps most importantly to the company, its bottom line.

### BRIEF SUMMARY

In summary, one aspect of the invention provides a method for creating alternative wellness activities based on tracked worker activity, the method comprising: utilizing at least one processor to execute computer code that performs the steps of: receiving, from one or more device sensors, a movement pattern of a user; identifying, based on the user movement pattern, an activity; determining, using at least one other device sensor, an alternative user movement pattern to achieve the activity, wherein said alternative user movement pattern increases an activity level of the user; and communicating, over a network, a message suggesting the alternative user movement pattern.

Another aspect of the invention provides an apparatus for creating alternative wellness activities based on tracked worker activity, the apparatus comprising: at least one processor; and a computer readable storage medium having computer readable program code embodied therewith and executable by the at least one processor, the computer readable program code comprising: computer readable program code that receives, from one or more device sensors, a movement pattern of a user; computer readable program code that identifies, based on the user movement pattern, an activity; computer readable program code that determines, using at least one other device sensor, an alternative user movement pattern to achieve the activity, wherein said alternative user movement patter increases an activity level of the user; and computer readable program code that communicates, over a network, a message suggesting the alternative user movement pattern.

An additional aspect of the invention provides a computer program product for creating alternative wellness activities based on tracked worker activity, the computer program product comprising: a computer readable storage medium having computer readable program code embodied therewith, the computer readable program code comprising: computer readable program code that receives, from one or more device sensors, a movement pattern of a user; computer readable program code that identifies, based on the user movement pattern, an activity; computer readable program code that determines, using at least one other device sensor, an alternative user movement pattern to achieve the activity, wherein said alternative user movement patter increases an activity level of the user; and computer readable program code that communicates, over a network, a message suggesting the alternative user movement pattern.

A further aspect of the invention provides a method for incentivizing the uptake of physical activities in a smart enterprise to maximize worker health, the method comprising: receiving sensor information from one or more sensors corresponding to a plurality of office workers; learning typical user activity based on the sensor information; generating alternate activity locations based on the sensor information; informing at least one office worker of an alternative activity location, the informing comprising offering an incentive; receiving additional sensor information from the one or more sensors corresponding to the at least one office worker; and based on the additional sensor information, determining if the at least one worker is entitled to receive the offered incentive.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of creating alternative wellness activities based on tracked worker activity.

FIG. 2 illustrates a method of monitoring the adoption of the alternative wellness activities and incentivizing said adoption.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

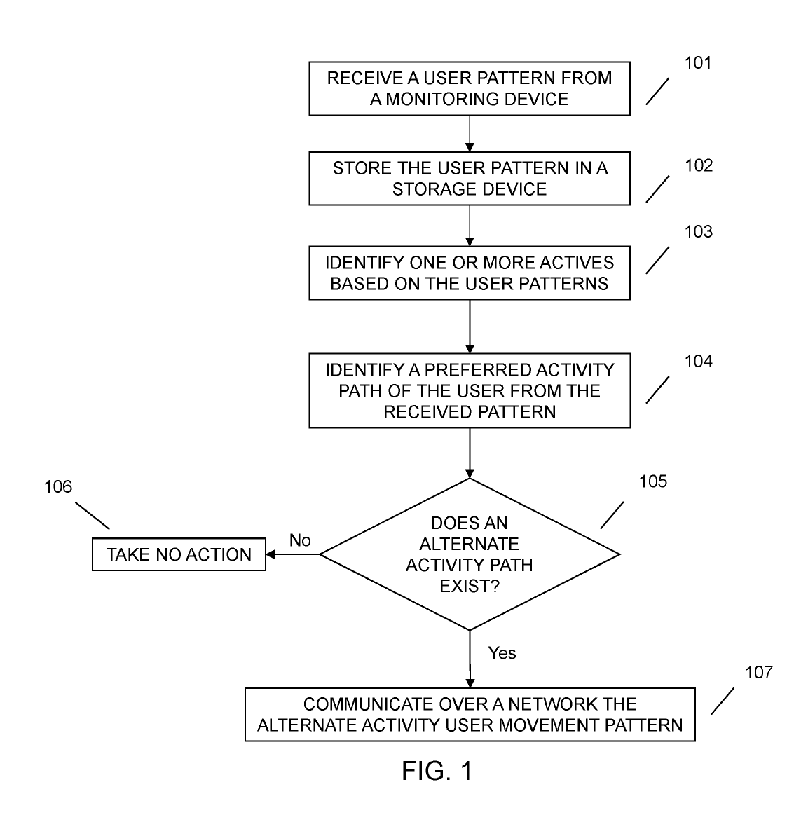

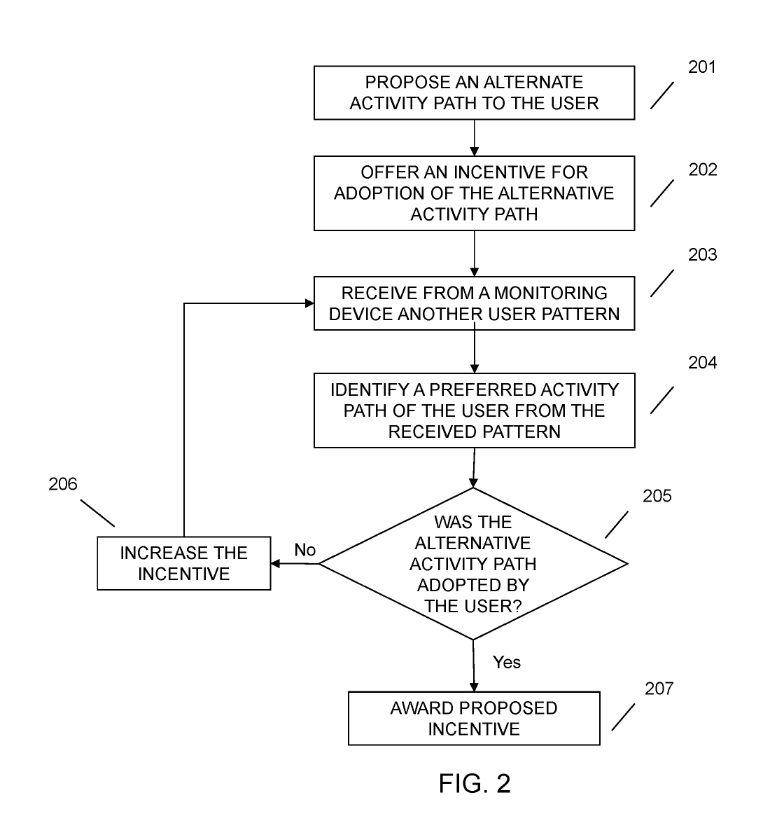

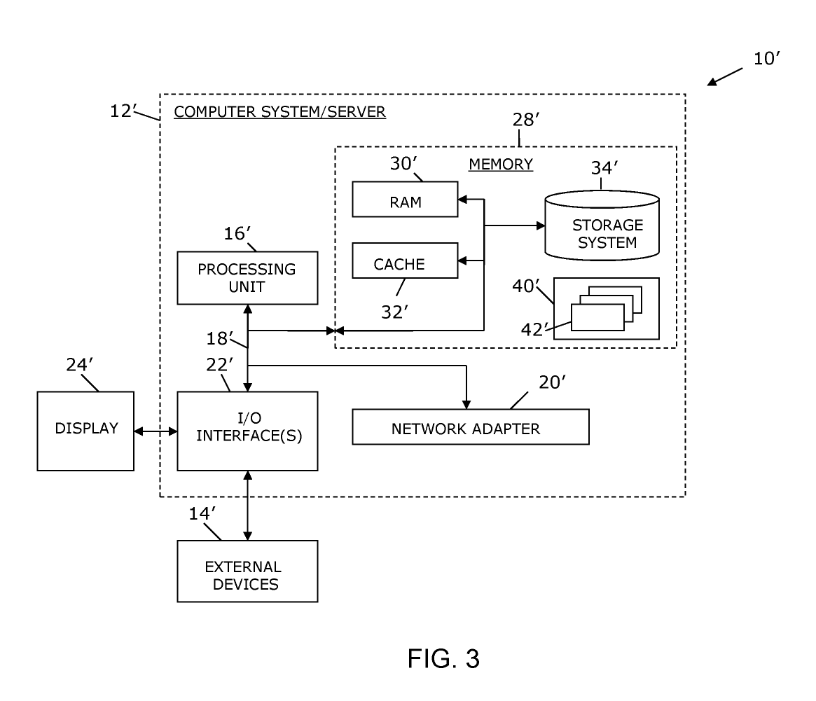

Specific reference will be made here below to FIGS. 1-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

As discussed herein, it has been determined that office workers who lead a more active lifestyle are healthier and have a higher working efficiency. In addition to improved efficiency, healthy employees are generally happier in their day to day lives and thus more likely to enjoy their jobs. This increased happiness can lead to improved retention rates and an overall improved working environment. Because of these benefits, companies have recently developed an interest in fostering or incentivize a healthy lifestyle within their staff. However, it can be difficult to create a healthy atmosphere in a work space. Employees are generally unreceptive to a rigid exercise regime in their workplace environment.

Thus, one of the most reliable means for improving worker activity through behavior modification is by suggesting low-effort recommendations. For example, an individual might not be willing to insert a one (1) mile jog around the building into their daily routine, but they may be willing to walk to the other side of the building to use the restroom versus the one next to their office.

Moreover, social cognitive theory, one of the most widely used behavioral theories, suggests that in order to voluntarily initiate an action, a person needs a sense of self-efficacy or confidence that they will be able to perform it. Thus, the more frequently the person can be triggered to partake in an activity (e.g., ride a bike) in a certain or specific context (e.g., where bikes are accessible), the more self-efficacy increases and the less exerting the behavior appears to be to an individual. Stated simply, the more a person carries out an activity, the more likely that activity will become a sustainable habit.

Currently, individuals or groups may monitor their personal fitness using fitness trackers (e.g., wearable devices, mobile applications on a smart phone, etc.). However, these devices fail to infer or learn current activities which are being undertaken by the user, for example, using context information from additional sources. This can lead to unhelpful results, such as poor recommendations for increasing a person's activity. For example, if a user is in a meeting, it is unhelpful to suggest that the user get up and go for a walk immediately. Moreover, currently the recommendations are typically generic in nature (e.g., yoga, running, standing up, etc.).

Accordingly, an embodiment provides a method of monitoring workers in a workplace environment using monitoring devices (e.g., fitness bands, smart watches, identification badges, motion sensors, etc.). Based on this monitoring, user patterns are identified and associated with some activity (e.g., the path to the restroom, lunch area, breakroom, etc.). These patterns are then stored (e.g., in a remote storage device or local storage device). The storage of these patterns allows an embodiment to create a historical database of specific user patterns and/or global user patterns (e.g., the path each worker takes to a specific location, such as the breakroom). An embodiment then identifies a preferred pattern or user path to a specific activity based on the historical information related to a specific user. Finally, an embodiment may suggest to the user a customized recommendation (e.g., an alternative activity path) which increases the user's exercise and/or fitness level, for example, suggesting the user go to a printer on the other side of the building instead of the one nearest their office.

Such a system provides a technical improvement over current systems for incentivized employee health programs based upon using an array of physical hardware devices (e.g., fitness trackers, wearable devices, identification badges, motion sensors, device sensors, etc.) to more accurately detect user patterns and offer alternatives that are more likely to be accepted as they are custom tailored to the individual. This is possible because an embodiment may involve a more comprehensive method of monitoring, which may only be accomplished in a controlled environment such as a work space or enterprise environment. Being inside of a building, which may have various monitoring systems on not only the workers, but also the rooms, common areas, and devices (e.g., refrigerators, copy machines, vending machines, etc.) allows an embodiment to more closely monitor user activity.

Turning now to FIG. 1, an embodiment may receive a user pattern from a monitoring device at 101. The monitoring device may be any device capable of monitoring a user's actions or location. Multiple non-limiting examples of monitoring devices are discussed herein, for example, a wearable device (e.g., a fitness tracker, smartwatch, wristband, smart glasses or eyewear, wearable camera, tokens or jewelry, or any equivalent device) which can be used to monitor an individual's physical movements and thus track overall activity as well as activity type. These non-limiting examples of wearable tech may be used individually or in combination with each other to improve their accuracy.

In an additional or alternative embodiment, the monitoring device may be an environmental monitoring device (e.g., a motion sensor, camera (e.g., security camera), audio capture device, infrared imaging device, room thermometer, radio-frequency identification reader and tag, short range wireless device and receiver, or any equivalent device) which can detect a user's activity in a specific space. As with the wearable tech, these non-limiting examples may be used individually or in combination with one another, for example connected via a network connection to each other.

In an even further embodiment, the monitoring device may be associated with a particular piece of equipment. For example, a printer may have a monitoring device that tracks how many times particular users print to the printer. It would be clear to one skilled in the art that these equipment monitors may be, for example, a network of physical objects: devices, vehicles, buildings and other items that are embedded with electronics, software, sensors, and network connectivity, thus enabling these objects to collect and exchange data. This technology may be generally referred to as the Internet of Things (IoT). Further examples of device monitoring are discussed herein.

In one embodiment, the user pattern that is received at 101 may be a user path to a specific location or activity. For example, each worker in a work space likely makes a trip to the breakroom at least once per day. Additionally, each worker is typically assigned a specific work space within the office (e.g., their desk or workstation). Thus, the path the individual takes from their work space to the breakroom is likely to be repetitive in nature. Because this pattern, or path, is repetitive, it can be identified as a regular pattern of the individual. Generally, an individual will have multiple patterns or paths they travel (e.g., walk, climb stairs, etc.) regularly throughout the day.

In another embodiment, these received and identified patterns are stored in a storage device at 102. This storage device may be local or remote, and may be private or accessible by multiple parties. In one embodiment, wherein the storage device is accessible via multiple parties, it may be possible to limit or restrict access based on a user's credentials. For example, a user may not wish to share the timing (e.g., time stamps) of their patterns, but may be ok with sharing the locations and paths associated with their known patterns. Thus, an embodiment may limit who or what application can view of the user's statistics (e.g., only an administrator can see the timestamps of the activity).

In a further embodiment, the storage device contains historical information about previous user patterns at 102. As discussed herein, the user patterns may be from a single user or multiple users. In one embodiment, the patterns of a single user are collected and organized in a user profile. This user profile helps identify the regular paths of a specific worker during a regular day or regular activities. In another embodiment, multiple user patterns are stored and used to create a global profile. This global profile may be used by an embodiment to identify the patterns of a large number of individual workers, and thus help identify important locations (e.g., breakrooms, restrooms, meeting rooms, etc.) within a business space (e.g., a single office building or multiple office buildings).

Once a profile has been created (e.g., a user profile and/or global profile) an embodiment may then determine one or more activities based on identified patterns within the historical pattern information at 103. Because most, if not all, worker activity is tracked, it can be difficult to determine which of the known paths or patterns should be analyzed to determine an activity. Thus, in one embodiment, all historical user patterns (e.g., user specific and global) may be compared against each other to determine which patterns are regularly repeated. An embodiment may then require that a predetermined number of similar patterns exist (e.g., above a threshold) before analyzing to determine an activity at 103. In a further embodiment, this threshold may be adjustable based on user (e.g., administrator, worker, etc.) preference, or adjusted via the software based on real-time statistics. For example, if the threshold for matching patterns is extremely high, it may be inefficient in a business with a small staff. Thus, an embodiment may adjust on the threshold after a predetermined amount of time (e.g., a week, month, etc.) if it determines insufficient user patterns are being received.

In one embodiment, the determination of the one or more activities at 103 may be done automatically. Additionally or alternatively, an embodiment may require a domain expert (e.g., a fitness consultant) to parse the data and identify useful activities from the historical user patterns. For example, an embodiment may utilize the known global patterns in conjunction with a floorplan of the office space to identify key areas such as meeting spaces, breakrooms, restrooms, water sources, etc. automatically. Additionally or alternatively, an embodiment may know the final destination of a user pattern based on preassigned room identifies. For example, if a workplace environment uses radio-frequency identification (RFID) badges to access particular rooms (e.g., a breakroom), an embodiment may obtain that room information from the building security system. Based on the room identification, a further embodiment may automatically determine the user activity being performed and associate it with the received user pattern at 103.

Thus, based on additional tracking methods, (e.g., RFID, camera, short-range wireless, motion detection, equipment monitoring, etc.) it is possible for an embodiment to automatically determine a user location based on associated timestamps and activities. By way of further example, a refrigerator and/or microwave in a breakroom may have sensor devices monitoring their usage, as discussed herein with regard to the Internet of Things. Thus, if it is detected that a user (e.g., worker) has been active in one of the predetermined patterns, an embodiment may determine that each time the user walks this specific path the refrigerator in breakroom A is opened. An embodiment may then determine that this user pattern or path is from the user's workstation to the breakroom A.

Additionally, an embodiment may use temporal data to determine user activity. In the previous example of the breakroom and refrigerator, an embodiment may know that the user walks this pattern each day at noon, and thus associate this pattern with the worker's lunch break.

As discussed herein, an embodiment may create a user profile based on a specific user's historical pattern. Using this information, a further embodiment may identify a preferred activity path for the specific user from the received patterns (e.g., historical patterns associated with the user profile) at 104. For example, if a worker always uses the same printer, it is likely he or she always take the same path from his or her workstation to the preferred printer. Thus, an embodiment would be able to determine a preferred activity path (e.g., when printing (the activity) a user always takes the same path to the same printer).

Once an embodiment determines a preferred path at 204, it may then reference the global profile, discussed herein, which stores historical user patterns from a plurality of users (e.g., all the workers in a particular office setting). Using the information within the global profile (e.g., the locations of all known activities and the preferred paths to get to those activities) an embodiment may identify an alternative path to a similar activity at 105. This recommendation is thus custom tailored to a specific user because an embodiment has identified an activity that the worker completes and suggested an alternative means of completion which increases the worker's fitness and/or activity level.

As a non-limiting example, an embodiment may determine that various other printers exist, and that by using a different printer a specific worker may increase his or her daily step count. Additionally, it may be determined that a second printer is the same distance away, but up a flight of stairs and thus a more active path. In one embodiment, a particular activity may have a large number of alternate paths available or a very limited number of alternatives. For example, in the above example using printers, there may be a large number of printers located throughout an office space. Thus, an embodiment may have a large number of options to choose from. Alternatively, in some cases, the options may be limited, for example there may only be a single breakroom, or a single breakroom on each floor of a building.

Once an embodiment determines at least one alternative activity path it may propose the alternate activity path to the user at 107. In one embodiment, multiple alternative paths may be suggested to a user based on the number of activities the user regularly completes. The selection of an alternate path(s) is customized by an embodiment to adapt to a specific user's current activity level. Thus, if one activity only has a single alternate path that would greatly increase the activity of the user, it may opt not to suggest that as it is less likely to be adopted.

However, one or more other activities may have alternate paths that contain very minor increases in activity, but which when combined create a moderate or desired level of physical activity increase, therefore allowing a user to select one or more of the suggested alternates and increase his or her activity level in a manner he or she chooses. It may also be possible that an embodiment finds no alternate paths of a given activity. Thus, an embodiment may take no action at 106.

Referring now to FIG. 2, once the alternative activity path is suggested to a user at 201 and 107, an embodiment may offer an incentive for a user to adopt the alternative at 202. These incentives may be work related (e.g., more paid time off, more break time during the day, longer lunches, additional work items such as a standing desk, etc.) or reward related (e.g., increase financial compensation such as a bonus, prizes such gift cards or physical gifts). Regardless of the incentive offered, a user must then determine if they want to adopt the alternative path and receive the incentive.

Once the incentive has been offered at 202, an embodiment continues to monitor the user's activity and receive additional user patterns at 203. For example, if an embodiment recommended that a specific user walk upstairs to print documents, and the user failed to do so, the monitoring devices would detect the user's movement and verify that the user failed to adopt the alternate path that was suggested. Based on the continued monitoring, embodiments, as previously discussed herein, may identify a preferred activity path for a specific user at 204. Based on the identified pattern at 204, an embodiment may determine if the alternative activity path was adopted by the user at 205.

If it is determined at 205 that the user adopted the alternative path, an embodiment may award the proposed incentive at 207 which was offered at 202. However, if it is determined at 205 that the user did not adopt the alternative path, an embodiment may increase the offered incentive at 206 in order to further entice the user to increase his or her activity level. Once the incentive is increased, an embodiment continues monitoring the user's patterns at 203, as discussed herein, to determine if further incentivization is required.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for creating alternative wellness activities based on tracked worker activity, the method comprising:
utilizing at least one processor to execute computer code that performs the steps of:
receiving, from one or more device sensors, a movement pattern of a user;
identifying, based on the user movement pattern, an activity;
determining, using at least one other device sensor, an alternative user movement pattern to achieve the activity, wherein said alternative user movement pattern increases an activity level of the user; and
communicating, over a network, a message suggesting the alternative user movement pattern.

2. The method of claim 1, wherein the one or more device sensors are at least one of: a wearable device, an equipment monitoring device, and an environmental monitoring device.

3. The method of claim 1, wherein the determining an alternate user movement pattern comprises:
receiving, from the at least one other device sensor, a plurality of user movement patterns from at least one other user;
identifying, based on the plurality of user movement patterns, one or more activities; and
matching the activity with at least one of the one or more activities.

4. The method of claim 3, wherein identifying one or more activities comprises: identifying one or more repetitive user movement patterns within the plurality of user movement patterns.

5. The method of claim 4, wherein the identifying one or more repetitive user movement patterns comprises:
determining a number of matching user movement patterns within the plurality of user movement patterns;
wherein the number of matching user patterns exceeds a predetermined threshold amount.

6. The method of claim 5, wherein the threshold amount is at least one of: user adjustable and software adjustable.

7. The method of claim 1, comprising offering, over the network, an incentive for adoption of the alternative user movement pattern by the user.

8. The method of claim 1, comprising:
determining if the user adopted the alternative user movement pattern based on receiving, from the one or more device sensors, at least one new user movement pattern, and
responsive to determining if the user adopted the alternative user movement pattern, performing an action selected from the group consisting of: increasing the incentive offered for adoption and awarding the offered incentive.

9. The method of claim 1, wherein the user movement pattern is associated with a group of users; and
wherein the communicating an alternative user movement pattern is communicated to the group of users.

10. An apparatus for creating alternative wellness activities based on tracked worker activity, the apparatus comprising:
at least one processor; and
a computer readable storage medium having computer readable program code embodied therewith and executable by the at least one processor, the computer readable program code comprising:
computer readable program code that receives, from one or more device sensors, a movement pattern of a user;
computer readable program code that identifies, based on the user movement pattern, an activity;
computer readable program code that determines, using at least one other device sensor, an alternative user movement pattern to achieve the activity, wherein said alternative user movement patter increases an activity level of the user; and
computer readable program code that communicates, over a network, a message suggesting the alternative user movement pattern.

11. A computer program product for creating alternative wellness activities based on tracked worker activity, the computer program product comprising:
a computer readable storage medium having computer readable program code embodied therewith, the computer readable program code comprising:
computer readable program code that receives, from one or more device sensors, a movement pattern of a user;
computer readable program code that identifies, based on the user movement pattern, an activity;
computer readable program code that determines, using at least one other device sensor, an alternative user movement pattern to achieve the activity, wherein said alternative user movement patter increases an activity level of the user; and
computer readable program code that communicates, over a network, a message suggesting the alternative user movement pattern.

12. The computer program product of claim 11, wherein the one or more device sensors are at least one of: a wearable device, an equipment monitoring device, and an environmental monitoring device.

13. The computer program product of claim 11, wherein the determination of an alternate user movement pattern comprises:
computer readable program code that receives, from the at least one other device sensor, a plurality of user movement patterns from at least one other user;
computer readable program code that identifies, based on the plurality of user movement patterns, one or more activities; and
computer readable program code that matches the activity with at least one of the one or more activities.

14. The computer program product of claim 13, wherein identifying one or more activities comprises: identifying one or more repetitive user movement patterns within the plurality of user movement patterns.

15. The computer program product of claim 14, wherein the identification of one or more repetitive user movement patterns comprises:
computer readable program code that determines a number of matching user movement patterns within the plurality of user movement patterns;
wherein the number of matching user patterns exceeds a predetermined threshold amount.

16. The computer program product of claim 15, wherein the threshold amount is at least one of: user adjustable and software adjustable.

17. The computer program product of claim 11, comprising computer readable program code that offers, over the network, an incentive for adoption of the alternative user movement pattern by the user.

18. The computer program product of claim 11, comprising:
computer readable program code that determines if the user adopted the alternative user movement pattern based on receiving, from the one or more device sensors, at least one new user movement pattern, and
computer readable program code that, responsive to the determination of if the user adopted the alternative user movement pattern, performs an action selected from the group consisting of: increasing the incentive offered for adoption and awarding the offered incentive.

19. The computer program product of claim 11, wherein the user movement pattern is associated with a group of users; and
wherein the communicating an alternative user movement pattern is communicated to the group of users.

20. A method for incentivizing the uptake of physical activities in a smart enterprise to maximize worker health, the method comprising:
receiving sensor information from one or more sensors corresponding to a plurality of office workers;
learning typical user activity based on the sensor information;
generating alternate activity locations based on the sensor information;
informing at least one office worker of an alternative activity location, the informing comprising offering an incentive;
receiving additional sensor information from the one or more sensors corresponding to the at least one office worker; and
based on the additional sensor information, determining if the at least one worker is entitled to receive the offered incentive.
